(19) United States
(12) Patent Application Publication
(10) Pub. No.: US 2013/0068958 A1
(43) Pub. Date: Mar. 21, 2013

(54) DETECTOR AND METHOD FOR DETECTING NEUTRONS

(71) Applicants: Bhaskar Mukherjee, Essen (DE); Jamil Lambert, Essen (DE); Reinhard Hentschel, Essen (DE); Jonathan Farr, Memphis, TN (US)

(72) Inventors: Bhaskar Mukherjee, Essen (DE); Jamil Lambert, Essen (DE); Reinhard Hentschel, Essen (DE); Jonathan Farr, Memphis, TN (US)

(73) Assignee: UNIVERSITAET DUISBURG-ESSEN, Essen (DE)

(21) Appl. No.: 13/699,643

(22) PCT Filed: May 26, 2010
(86) PCT No.: PCT/EP10/03184

§ 371 Date: Nov. 23, 2012

(51) Int. Cl. G01T 3/00

(52) U.S. Cl. CPC G01T 3/00
USPC 250/391; 250/390.01

(57) ABSTRACT

A neutron detector includes a bulk of a neutron moderating material, a first housing consisting of or comprising a gamma ray attenuating material, a second housing consisting of or comprising a gamma ray attenuating material, a first sensor device comprising a gadolinium cover disposed in the first housing, and a second sensor device disposed in the second housing. The first sensor device and the second sensor device are each sensitive to gamma rays. The first housing and the second housing are arranged adjacent to each other in the bulk.

### CROSS REFERENCE TO PRIOR APPLICATIONS

This application is a U.S. National Phase application under 35 U.S.C. §371 of International Application No. PCT/EP2010/003184, filed on May 26, 2010. The International Application was published in English on Dec. 1, 2011 as WO 2011/147427 A1 under PCT Article 21(2).

### FIELD

The present invention relates to a detector and to a method for detecting neutrons.

### BACKGROUND

The smuggling of nuclear contraband material through road, railway and maritime networks poses a great concern to today's modern civilized society. There are, broadly, two types of nuclear contrabands of concern: (a) gamma ray emitting radioactive scrap materials and orphan sources, which could be primarily used for the construction of “dirty bombs”, and (b) fissile material i.e., ²³⁹Pu (accompanied by ²⁴⁰Pu) usually generated in spent fuel elements of low-enriched uranium (LEU) power and research reactors, which could be used to develop potentially far more disastrous “nuclear devices”.

The trafficking of an intact standard nuclear warhead through international check posts seems to be unfeasible; on the other hand, common civilian reactor grade plutonium (i.e., spent fuel elements) could easily be smuggled through transit points and be used to construct low-technology nuclear devices up to an explosive yield of approximately 0.52 kt (TNT equivalent).

While it is not very difficult to detect gamma ray emitting material with well known detectors, it is on the other hand even more complicated to detect neutrons emitted by fissile material.

In the state of the art, it is known to use active neutron detectors because, in most cases, the level of spontaneous fission from the smuggled nuclear materials is not high enough for reliable detection. In this kind of detector, the area of interest, i.e., a suspected cargo concealing those materials, is irradiated with fast neutrons from a dedicated particle accelerator in order to induce nuclear fission resulting in the production of secondary neutrons and gamma rays. Custom-designed neutron and gamma detectors are used to assess those secondary radiations, thereby identifying the nuclear contraband. These kind of detectors are accordingly themselves dangerous, expensive and only suitable to detect bigger amounts of fissile material.

Passive detectors are also known. As mentioned earlier, reactor grade plutonium containing 5.8% (per weight fraction) ²⁴⁰Pu belongs to one of the most notorious illicit nuclear weapon materials and emits spontaneous fission neutrons. A passive detector can be used to identify contraband by detecting these spontaneous fission neutrons.

²⁴⁰Pu emits “spontaneous fission” neutrons (˜2.5×10⁶ neutrons s⁻¹ kg⁻¹), and this neutron signature can be detected using a suitable neutron detector resulting in the identification of smuggled fissile contraband.

The implementation of an efficient detector or sensing devices for swift and foolproof identification of clandestine trafficking of nuclear materials like plutonium, uranium and thorium has now became imperative to defer nuclear proliferation and associated terrorism threats.

Low cost, small size and simple operation are the distinct advantages of a passive nuclear contraband detector over an active detector, however, the major current limitation is their low sensitivity, specified as lowest level of detection (LLD).

As only 4.8 kg smuggled reactor grade plutonium is sufficient to construct a “low technology” nuclear device, a potential terrorist organization could try to traffic the plutonium in small aliquots to avoid detection by conventional passive nuclear contraband detectors. This poses the greatest challenge of an efficient passive nuclear contraband detector.

### SUMMARY

An aspect of the present invention is to provide a detector and a method for detecting neutrons having high detection sensitivity and thus providing the possibility of detecting very little amounts of fissile material, in particular, in the range of less than 10 grams, for example, less than 3 grams. An alternative aspect of the present invention is to provide a detector and method capable of detecting small amounts of fissile contraband.

In an embodiment, the present invention provides a neutron detector which includes a bulk of a neutron moderating material, a first housing consisting of or comprising a gamma ray attenuating material, a second housing consisting of or comprising a gamma ray attenuating material, a first sensor device comprising a gadolinium cover disposed in the first housing, and a second sensor device disposed in the second housing. The first sensor device and the second sensor device are each sensitive to gamma rays. The first housing and the second housing are arranged adjacent to each other in the bulk. For the present invention, thermal neutrons are deemed to have an energy of less than 100 meV. At room temperature, the thermal energy of neutrons is 0.025 eV.

### BRIEF DESCRIPTION OF THE DRAWINGS

The present invention is described in greater detail below on the basis of embodiments and of the drawings in which:

FIG. 1a: shows an embodiment using thermoluminescent detectors;

FIG. 1b: shows an embodiment using optical stimulatable luminescent detectors;

FIG. 2: shows the glow curves of two sensor devices;

FIG. 3: shows the neutron fluence as a linear function of net thermoluminescence counts; and

FIG. 4: shows a flow charts of the method of the present invention.

### DETAILED DESCRIPTION

During deceleration, gamma rays are emitted by the moderator material, in particular due to scattering. Any kind of suitable moderator material may be used for this purpose. Hydrogen-containing materials may, for example, be used, for example, polyethylene, for example, in a high dense pure form or with admixtures. The thickness of the moderator material is to be chosen in order to avoid a total capture of the neutrons and to provide thermal neutrons for further processing according to the present invention. The moderating distance in polyethylene may be chosen in the range of 10 to 20 cm.

Since the production of gamma rays in the moderator material cannot be avoided, these gamma rays will furthermore be attenuated and preferably totally shielded. Any gamma ray attenuating/shielding material is suitable for this purpose, for example, lead, gold, wolfram.

In order to obtain information about this undesired background gamma radiation (in case gamma radiation remains after shielding) according to the present invention, a first and a second sensor device, which are both sensitive to gamma rays, are irradiated with the attenuated gamma rays.

Such a sensor device according to the present invention may be any device that is capable of providing a readable measure that is dependent, for example, to the total gamma ray fluence received within in a certain time interval. A sensor can, for example, be an integrating sensor, such as thermoluminescent crystals or optically stimulatable crystals.

In the present invention, the thermalised/decelerated neutrons are captured with gadolinium and thus additional gamma rays are produced in a neutron-gadolinium-interaction. It has been proven that gadolinium has a very high, if not the highest, known neutron capture cross section for thermal neutrons. If any other material may become available with a higher or at least similar neutron capture cross section, such a material may be used instead as an equivalent to gadolinium.

According to the method of the present invention, only the first sensor device will be irradiated with this additional gamma rays produced in gadolinium and this additional gamma radiation is shielded or at least strongly attenuated in order to prevent substantive irradiation of the second sensor.

As a consequence, both sensor devices are sensing or measuring the gamma radiation produced during deceleration in the moderator and any background gamma radiation, but only the first sensor device is (additionally) sensing or measuring the additional gamma radiation caused only by the neutron-gadolinium-interaction.

According to the present invention, a signal proportional to the received total fluence of gamma rays is read from both respective sensor devices. These two signals may be compared in order to receive information about the total neutron fluence received within a certain time. For example, a comparison may be performed by simply subtracting the signal of the second sensor device from the signal of the first sensor device. The result accordingly only represents the gamma ray fluence produced by the neutron-gadolinium-interaction and thus may be used to measure the neutron fluence.

In an embodiment of the present invention, the signals of first and second sensor devices are compared and an alarm signal may be generated dependent upon the result of comparison. The method accordingly provides a measure to detect fissile material in the vicinity of the sensor devices.

In an embodiment of the present invention, the sensor device may be composed of a thermoluminescent material, in particular, a carbon-doped alumina which has a very high sensitivity to gamma radiation. In such a case, the signal of each of the two sensors devices may be read by means of heating the respective sensor device and collecting and detecting the emitted light.

In an embodiment of the present invention, the sensor device may be composed of an optically-stimulatable material, for example, carbon doped alumina (α-Al₂O₃:C). In this case, a signal proportional to the total gamma radiation fluence received within a certain time may be generated by the sensor device by irradiating this device with a specific wavelength. After an irradiating pulse of this specific wavelength, the device produces a light pulse of another wavelength, for example, by luminescence. According to this embodiment of the present invention, an in-situ readout of the two sensor devices may be performed, for example, periodically after a certain time of integrating the gamma radiation. Irradiation with and readout of the light pulses may be performed using optical fibers.

The present invention also provides a detector comprising a first and a second sensor device, both being sensitive to gamma rays, the first sensor device being covered with gadolinium and the covered first sensor device and the second sensor device each being placed in a housing consisting of or at least comprising a gamma ray attenuating material, in particular, lead. The housings of both sensor devices are furthermore positioned adjacent to each other in a bulk of a neutron-moderating material, in particular, the middle of such a bulk. The method of the present invention may be performed using such a detector.

Covering the first sensor device with gadolinium does mean that a neutron on its way from the point of emission to the sensor device will pass through the gadolinium material. In an embodiment of the present invention, the sensor device can, for example, be surrounded by gadolinium material, i.e., covered on all sides. Such an embodiment has the advantage that the detector according to the present invention does not need to be aligned, since neutrons from any direction will pass through the gadolinium. A gadolinium foil may, for example, be wrapped around the sensor device. It is also possible to form a pot of gadolinium and a covering lid in order to place the sensor device in the pot and to close it with the lid.

In order to provide attenuation of the gamma radiation produced during deceleration, a respective housing is provided for the first sensor covered with gadolinium and the second sensor. Both housings may be formed commonly. In an embodiment of the present invention, the housings of the two sensor devices may be formed as a bottom part having adjacent recesses for the sensor devices and a cover part, both parts consisting of or at least comprising a gamma ray attenuating material, in particular, lead, gold or wolfram.

In the present invention, the housing of the first and/or the second sensor device also prevents gamma radiation produced in the gadolinium at the site of the first sensor device to irradiate the second sensor device. This is best achieved if the gamma ray attenuating material of the housing surrounds the sensor devices in total.

A detector according to the present invention will have a high reliability and sensitivity if the first and second sensor devices have the same sensitivity to gamma rays. This may be provided, for example, if the first and second sensor devices are empirically selected from a certain amount of sensor devices. For example, all the sensor devices of this certain amount may be irradiated with the same total gamma radiation fluence from any kind of source and the retrieved signal from all the devices may be compared. It is then possible to choose two sensor devices of this total amount having the smallest difference of their respective signals, in particular, of their glow curves if luminescent sensor devices are used.

In an embodiment of the present invention, the first and the second sensor device can be selected from one of the following materials: carbon-doped alumina, in particular, α-Al₂O₃:C, titan and magnesium-doped lithium fluorid, LiF:Ti, Mg or dysprosium-doped calcium fluorid, in particular, CaF₂:Dy. Carbon-doped alumina, for example, has a high sensitivity to gamma radiation.

In an embodiment of the present invention, the bulk of the neutron moderating material consists of or comprises polyethylene in pure form or with admixtures. Of course, all other suitable materials may be used. The bulk can, for example, be in the form of a sphere or cylinder, in the middle of which the housings of the two sensor devices are placed adjacent to each other. In this embodiment, high energy neutrons will have to pass through almost the same amount of moderating material until capture in the gadolinium irrespective of their direction.

In order to read a signal from each of the two sensors devices, in one possible embodiment, these two devices may be removed from their housings and the first sensor device will also be removed from the gadolinium casing. Both sensor devices may be heated, thus producing luminescence that may be detected as a measure for gamma radiation and/or neutron fluence.

In order to provide instant measurement, it is also possible to use optically-stimulatable luminescent materials such as the aforementioned crystals, in particular, α-Al₂O₃:C

In an embodiment, at least one optical fiber is fed through the housing of each sensor device, in particular, also through additional cover material of each sensor device, in particular, also through the gadolinium cover of the first sensor device, in particular, also through the bulk of neutron moderating material, one end of the at least one fiber facing one of the sensor devices, the other end being connected/connectable to a light source and/or light detector.

One or more stimulating light pulses may accordingly be applied to the crystals of the two sensor devices for generating luminescent light after switching off the pulse. The luminescent light of a different wavelength may be collected from the respective crystal with the same or another optical fiber and may be directed to a light detecting device, for example, a multiplier or photo diode thus providing a measurable signal.

In order to improve such a luminescent signal, it is also possible to place a reflective material around the sensor devices. Of course, an optical fiber also needs to pass through this reflective material.

Two embodiments of the present invention will be shown in the drawings.

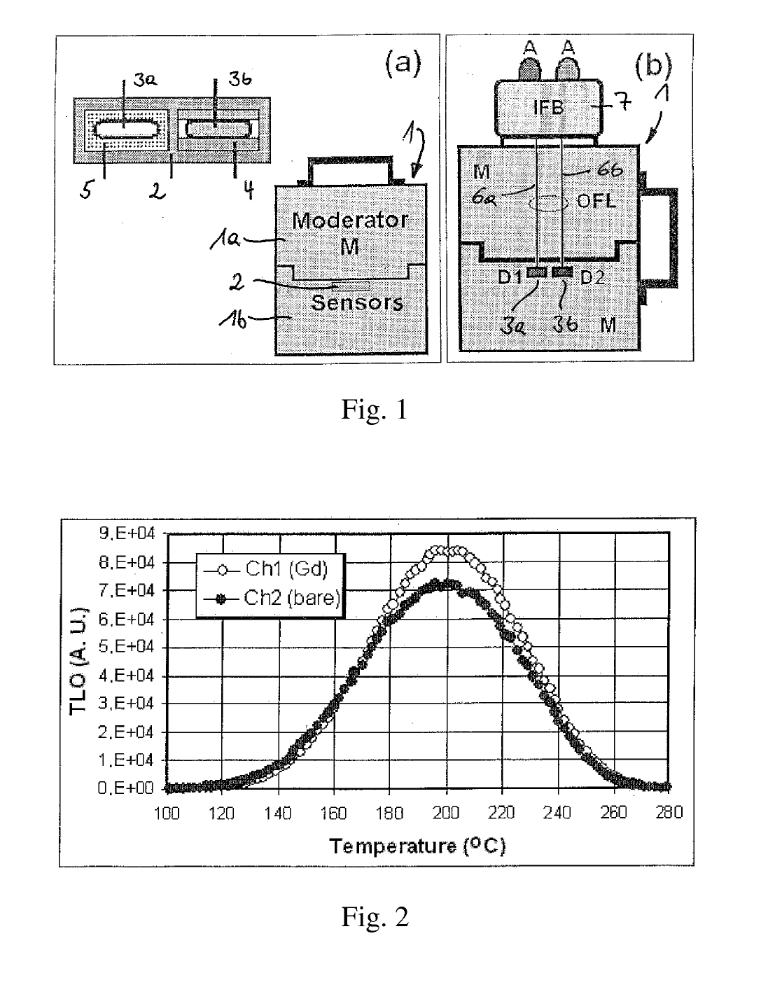

FIG. 1 illustrates two possible embodiments. According to FIG. 1a, a cylinder 1 made of polyethylene is used as a moderator to decelerate neutron received from any direction. The cylinder is separated into an upper part 1a and a lower part 1b. After lifting the upper part, approximately in the middle of the cylinder 1, a housing 2 made of gamma radiation attenuating material (such as lead) is placed. This housing 2 receives a first sensor device 3a and a second sensor device 3b in respective recesses that are positioned adjacent to each other. The first sensor device 3a is cased in gadolinium 5 that surrounds the sensor device 3a on all sides. In order to get almost the same position of the second sensor device 3b (which is not encased), this second sensor device 3b is placed between additional spacers 4 made of any material that does not affect gamma radiation, for example, made of cardboard. In this embodiment, the gamma radiation attenuating material also extends between the two sensor devices 3a, 3b in order to prevent gamma radiation produced in the gadolinium 5 from irradiating the second sensor device 3b.

Furthermore, in this embodiment, the sensor devices are carbon-doped alumina, α-Al₂O₃:C.

Natural gadolinium possesses a very high thermal neutron capture (n, γ) cross section and by combining this with the high sensitivity to gamma rays of carbon-doped aluminium oxide thermoluminescence material, for example, known from dosimeters TLD 500, a highly sensitive passive neutron detector was developed. As the sensor devices, two TLD 500 chips of exactly the same sensitivity were used. The first chip 3a was covered with a 0.2 mm thick gadolinium foil 5 and the second chip 3b with thin spacers 4 made of cardboard. Both chips were wrapped with 2×3 mm thick lead layers 2 to build the housing and placed in an 18 cm diameter×18 cm long polyethylene moderator cylinder 1.

Natural gadolinium contains 15.65% Gd-157 with an extremely high (255000 b) thermal neutron capture cross section. Thermalised neutrons interact with the gadolinium foil producing 80 (11.5%) and 182 (13.6%) keV gamma rays via the 157Gd(n, γ)158Gd reaction, thereby exposing only the chip 3a.

However, both TLD chips 3a and 3b receive low-level exposure from the neutron capture gamma rays from polyethylene, attenuated by the lead housing 2. The signal of TLD chip 3b was subtracted from that of chip 3a, the difference being associated with the neutron dose. The signals are shown in FIG. 2 and measured during heating of the respective sensor device chips 3a and 3b. The higher glow curve corresponds to the signal of the chip 3a being covered with gadolinium. The glow curves of the two TLD 500 chips 3a and 3b were received after they were irradiated with neutrons from a ²²⁶Ra/Be source to a dose equivalent of 48 μSv. The increased signal from chip 3a is due to the gamma rays produced in the gadolinium foil due to the neutron fluence. The difference between the two glow curves (ACounts) relates to the integrated neutron fluence.

Evidently, the performance of this neutron monitor depends primarily on the same sensitivity of both chips. In this embodiment, pairs of TLD500 chips from a pool of 150 chips have been randomly selected and irradiated with gamma rays from a ¹³⁷Cs source to 50 μSv. The thermoluminescence glow curves were recorded at a heating rate of 5° C. per second using a Harshaw Model 3500 reader. The best chips 3a and 3b with the corresponding glow peak areas within ±3.5% were selected.

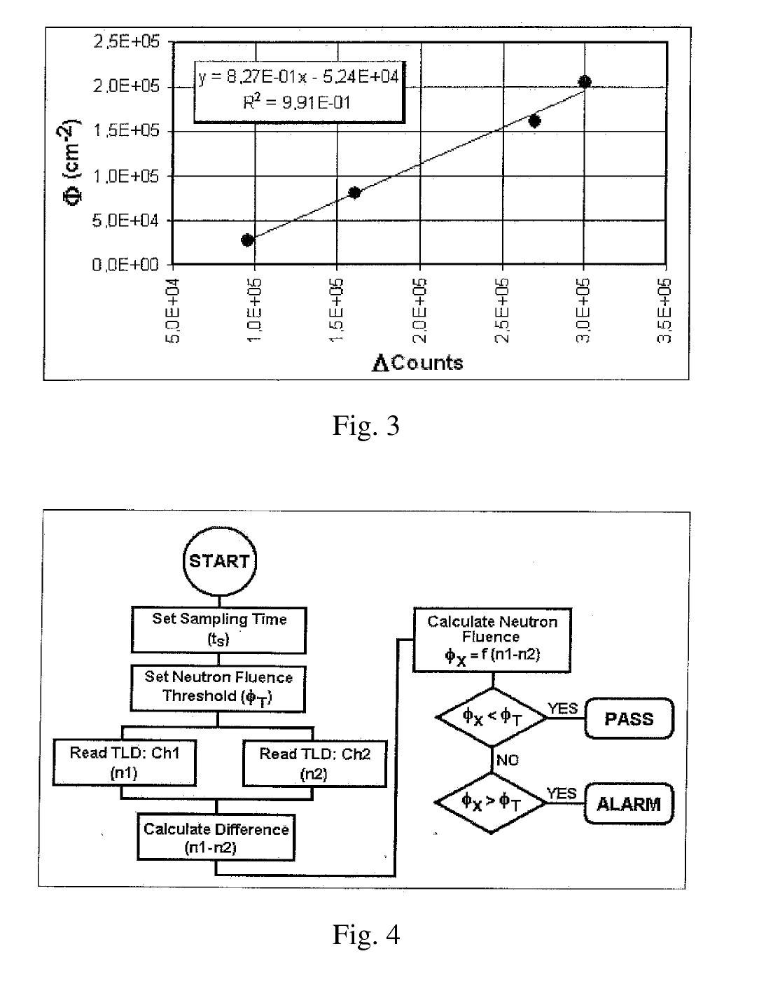

The neutron fluence detector according to FIG. 1a was irradiated with neutrons from a Ra/Be source to 6.6, 19, 38 and 48 μSv. The neutron dose equivalents were evaluated using superheated emulsion (bubble) detectors according to a known procedure described elsewhere. The TLD chips were taken out from the neutron detector and evaluated. The neutron fluence was calculated using the “neutron fluence to dose equivalent conversion factor” and plotted as a linear function of net TL counts as shown in FIG. 3. FIG. 3 shows that there is a linear relation between the ACounts and the neutron fluence. The relation shown in this figure can then be used as a calibration curve to calculate the neutron fluence for a given ACounts, which is the area of counts between the integrated signal of the two sensor devices.

A neutron fluence as little as 7.1 neutrons cm⁻² s⁻¹ for an integration period of 1 hour was measurable. This detection level is adequate enough to detect 3 grams of reactor grade plutonium from a distance of 1 meter. Accordingly, an application of this detector is suggested for the passive detection of nuclear contraband, for example, at airports, postal offices and the like.

In FIG. 1b, optically-stimulatable sensor devices 3a and 3b are used instead of thermoluminescent devices. Sensor 3a is again surrounded by gadolinium and both are placed in a lead housing and positioned adjacent in the polyethylene cylinder 1.

By means of optical fibers 6a and 6b, the luminescence signal of the respective sensors devices 3a and 3b may be read by stimulating the devices 3a and 3b with a specific wavelength, green light in the case of carbon-doped alumina. A light-emitting device (not shown) and a light detection device (not shown) may be provided in an alarm generator 7 comparing the two received signals.

For a swift and fault free routine assessment of the neutron fluence, a simple evaluation protocol for the TLD chips has been developed as follows and shown in FIG. 4. This is applicable for both embodiments of FIGS. 1a and 1b.
(i) Set sampling time (ts),
(ii) Set neutron fluence threshold (Φt),
(iii) Read TLD chips ch1 (3a) and ch2 (3b),
(iv) Calculate the difference between the area under the glow peak curves for the two TLD chips (n1-n2),
(v) Use the difference between the two glow peaks to calculate neutron fluence Φx by using a linear fitting function, for example, the one of FIG. 3,
(vi) Compare calculated fluence Φx with threshold fluence Φt with the following outcome:

if Φx<Φt=>PASS (a)

if Φx>Φt=>ALARM (b)

The present invention is not limited to embodiments described herein; reference should be had to the appended claims.

What is claimed is:

1-11. (canceled)

12. A neutron detector comprising:
a bulk of a neutron moderating material;
a first housing consisting of or comprising a gamma ray attenuating material;
a second housing consisting of or comprising a gamma ray attenuating material;
a first sensor device comprising a gadolinium cover disposed in the first housing; and
a second sensor device disposed in the second housing,
wherein,
the first sensor device and the second sensor device are each sensitive to gamma rays, and
the first housing and the second housing are arranged adjacent to each other in the bulk.

13. The neutron detector as recited in claim 12, wherein the gamma ray attenuating material is lead.

14. The neutron detector as recited in claim 12, wherein the first housing and the second housing are arranged in a middle of the bulk.

15. The neutron detector as recited in claim 12, wherein the first sensor device and the second sensor device each have a same sensitivity to gamma rays.

16. The neutron detector as recited in claim 15, wherein the first sensor device and the second sensor device are empirically selected from a certain amount of sensor devices.

17. The neutron detector as recited in claim 12, wherein the first sensor device and the second sensor device each comprise at least one of a carbon-doped alumina such as α-Al₂O₃:C, a titan and magnesium-doped lithium fluorid (LiF:Ti, Mg), and a dysprosium-doped calcium fluoride (CaF₂:Dy).

18. The neutron detector as recited in claim 12, wherein the bulk consists of or comprises polyethylene in a pure form or polyethylene with admixtures.

19. The neutron detector as recited in claim 18, wherein the bulk is provided in a shape of a sphere or a cylinder.

20. The neutron detector as recited in claim 12, wherein the first housing and the second housing each comprise a bottom part with an adjacent recess for the respective first sensor device and second sensor device, and a cover part, wherein the bottom part and the cover part consist of or comprise a gamma ray attenuating material.

21. The neutron detector as recited in claim 20, wherein the gamma ray attenuating material is lead.

22. The neutron detector as recited in claim 12, further comprising at least one optical fiber, wherein the at least one optical fiber is fed through the first housing and through the second housing, a first end of the at least one fiber faces the first sensor device or the second sensor device, and a second end of the at least one fiber is connected to or is configured to be connectable to at least one of a light source and a light detector.

23. The neutron detector as recited in claim 22, wherein the at least one optical fiber is additionally fed through at least one of an additional cover material of the first sensor device, an additional cover material of the second sensor device, the gadolinium cover of the first sensor device, and the bulk.

24. The neutron detector as recited in claim 23, further comprising a reflective material placed around each of the first sensor device and the second sensor device.

25. A method of detecting neutrons emerging from an area of interest to a neutron detector, the method comprising:
decelerating neutrons to a thermal energy with a moderator material so as to provide thermalised/decelerated neutrons;
attenuating gamma rays emitted by the moderator material during the deceleration so as to provide attenuated gamma rays;
irradiating a first sensor device and a second sensor device sensitive to gamma rays with the attenuated gamma rays;
capturing the thermalised/decelerated neutrons with gadolinium to produce gamma rays via a neutron-gadolinium-interaction;
irradiating the first sensor device but not the second sensor device with the gamma rays produced via the neutron-gadolinium-interaction; and
reading a signal proportional to a received total fluence of gamma rays from the first sensor device and from the second sensor device.

26. The method as recited in claim 25, further comprising:
comparing the signals from the first sensor device and from the second sensor device; and
generating an alarm signal dependent upon a result of the comparing.

27. The method as recited in claim 25, wherein the first sensor device and the second sensor device are each composed of a thermoluminescent material, and wherein the reading of the signal from each of the first sensor device and the second sensor device is provided by heating the respective first sensor device and the second sensor device.

28. The method recited in 25, wherein the first sensor device and the second sensor device are each composed of an optically stimulatable material, and wherein the reading of the signal from each of the first sensor device and the second sensor device is provided by irradiating the respective first sensor device and second sensor device with a light, and receiving a fluorescent or a luminescent light from the respective first sensor device and second sensor device.
